(19) United States
(12) Patent Application Publication
(10) Pub. No.: US 2005/0281929 A1
(43) Pub. Date: Dec. 22, 2005

(54) Composition for delivering a high intensity sweetener

(76) Inventor: Thomas E. Sox, Ambler, PA (US)

Correspondence Address: PHILIP S. JOHNSON;JOHNSON & JOHNSON, ONE JOHNSON & JOHNSON PLAZA, NEW BRUNSWICK, NJ, 08933-7003, US

(21) Appl. No.: 11/211,251

(22) Filed: Aug. 25, 2005

Related U.S. Application Data
(62) Division of application No. 10/283,854, filed on Oct. 30, 2002.

(51) Int. Cl. A23L 1/236

(52) U.S. Cl. 426/548

(57) ABSTRACT

A composition and a device for sweetening products including a sweetening solution, wherein the sweetening solution consists essentially of a high intensity sweetener and a solvent, and a spraying apparatus are disclosed.

### FIELD OF THE INVENTION

This invention relates to a composition and method for delivering a high intensity sweetener solution. The composition includes a solution of at least one high intensity sweetener in a spraying device.

### BACKGROUND OF THE INVENTION

High intensity sweeteners (HIS), such as, sucralose, provide a means for sweetening products without introducing a caloric burden. However, consumers differ considerably in the amount of sweetness that they prefer in foods and beverages. For example, the sweetness level incorporated into a product during preparation may not be sufficient to satisfy some consumers. Therefore, there exists a need for compositions and methods for delivering sweetness levels of products that enable consumers to increase the sweetness level of a product at the time of consumption that is consistent with their personal preference, without introducing an additional caloric burden.

Packets of dry HIS are typically used for such applications. However, such packets possess a number of disadvantages. For example, once opened, the entire packet must be used or discarded, since there is no simple way of storing an opened packet containing HIS for future use. Also, each empty packet generates packaging waste that must be disposed. Furthermore, individual packets are inconvenient to carry.

Liquid HIS products have also been developed. Typically, liquid HIS products are dispensed in a dropwise manner that can produce localized areas of intense sweetness on food surfaces. These also suffer from several disadvantages. For example, although the liquid HIS products can be easily mixed into a beverage, such as, coffee or tea, it is not feasible to spread the liquid evenly over a serving of solid food, such as a bowl of fruit, a bowl of cereal, or popcorn. Additionally, non-uniformity of drops delivered from a squeeze-type liquid dispenser can result in variability in the amount of sweetness delivered per dose.

The present invention is directed to a liquid sweetener composition having at least one HIS in a portable container from which the sweetener is dispensed as a spray at the point of use. A spray device, i.e., sprayer, that produces relatively uniform droplet sizes further improves the distribution of the liquid sweetener composition on the product to be sweetened. This spray can be directed over the surface of the serving of food, thereby obtaining a fairly uniform distribution of the sweetener. Current liquid or packet HIS products cannot generally achieve this uniformity of sweetening effect.

Many methods can be used to produce the spray, and the scope of this invention is not limited to a specific spray generating mechanism. For example, a pressure tight container may be used, in which pressure is provided by a propellant gas or other suitable propellant source, and the HIS composition is dispensed through a nozzle that is actuated by the consumer.

One known pressurized dispenser system avoids the use of separate propellant gases. In such a system, a piston is used to charge an expandable reservoir with air, thereby generating a pressure inside the dispenser that permits the formation of an aerosol spray when an actuator valve is depressed.

Alternatively, a pump sprayer with which a consumer can generate a measured spray by squeezing or depressing a pump handle may be used to practice this invention. For example, a manual atomizing pump in which the volume of material dispensed is precisely controlled provides the delivery of valuable materials, such as, perfumes, pharmaceuticals, or high intensity sweeteners.

Another known atomizing pump permits the adjustment of the volume of material dispensed by varying the length of the pump stroke during dispensing. The amount of volume dispensed by each stroke is displayed by the alignment of a guide marker with calibration numbers on the dispensing pump means.

An additional known spray aerosol dispenser with a pistol type grip allows two or more fingers to be used in squeezing the pump spray apparatus. This design is especially useful for dispensing a high intensity sweetener under conditions of large volume applications or repetitive multiple uses. Examples of situations in which this feature is advantageous include the spraying of sweetener onto the surface of donuts or pastries in a bakery, or the spraying of sweetener onto multiple servings of fruit, as may be needed in a cafeteria.

Another approach for achieving the objectives of the current invention is through the use of a flexible container that is squeezed to expel a mixture of air and aerosolized HIS composition. Releasing the pressure on the container allows the container to refill with air, thereby charging it for the next product dispensing cycle. Another spray bottle design permits the adjustment of the amount of material dispensed per spray. This feature is particularly useful in the area of the current invention, since this potentially permits the user to adjust the amount of sweetener dispensed onto food product consistent with the consumer's preference for sweetness level and the amount of food that is being sweetened.

An atomizer bottle is known in which the amount of material dispensed during each cycle of squeezing is not reduced as the amount of liquid in the bottle is reduced by consumption, as well as not increasing the amount of force needed to create a spray aerosol as the contents of the bottle are depleted.

A spray device with folding actuator is also known. When this device is in the storage position, two hinged elements are folded together so as to cover the end of the dispensing nozzle, thereby protecting it from foreign material that could cause contamination or obstruct the nozzle opening. In the use position, the two hinged elements are folded back about 90 degrees, thereby forming a handle mechanism that can be grasped and used to depress the actuator. Such a device provides a portable spray device in which the nozzle is protected when the device is not in use, but avoids the need for a separate cap that could be lost or displaced.

Aerosol or spray devices have been used to apply materials to foods during their final preparation, or just before their consumption. For example, an aerosol food flavoring composition that includes a concentrate of primarily food grade oil, undissolved solids, and an emulsifier system. This composition is typically used primarily to provide butter, cheese, or caramel flavors directly to the surface of foods. The caramel form is known to contain fondant sugar as a sweetener.

A sprayable composition for use as a pan release agent in bakeries; the composition contained a liquid emulsifier of monoglycerides, diglycerides, polysorbate, and at least 80% water is also known.

The use of supercritical fluid sprays to apply various materials to food substrates is known. Such sprays avoid the use of sprayed oils, thereby reducing the fat content of products. Known supercritical fluid sprays are used to deliver a number of food additives, including flavors and HIS, such as, saccharin, sodium cyclamate, acesulfame K, aspartame, and sucralose. Although supercritical fluid sprays may have great utility in industrial food processes, they are not suitable for consumer application of materials to foods at the time of consumption because of the very great pressures involved. Additionally, such pressures cannot be achieved with current aerosol can technology.

Also known is an aerosol dispensable composition of whipping cream that contains soy protein, oils, and emulsifiers. The composition is known to contain cane sugar (sucrose) as a sweetener.

A foamy aerosol dispensable composition having a frothing agent, a sweetener, a thickener, water, flavor and color, and propellant is known. In such a dispenser, sucrose was the preferred sweetener, but the use of HIS, such as, aspartame or saccharin is also disclosed. Such a dispenser suffers from many drawbacks for delivering sweeteners because of the foamy product produced therefrom. Such foam makes it difficult for consumers to evenly coat the product on which the sweetener composition is being added.

Compositions for delivering HIS to the surface of food products as a dried foam layer are known. It is known that the foam is generated by creation of microcapsules during the spraying operation. The encapsulation carrier is ideally a starch hydrolysate, e.g., a maltodextrin or oligosaccharide. A dried foam layer is achieved by applying a foaming spray to the surface of a product while the product is agitated and conditions are provided to facilitate evaporation of the solvent used to generate the foam.

A spray assembly for delivering sweetened compositions is also known. The spray assembly can be snapped directly onto the top of bottle containing sweetener compositions for delivering a candy flavor or a dessert flavor. Such compositions require the use HIS, including sucralose, and a flavor component. It is also known that such compositions typically use from 25.25 to 43.75 weight percent of high fructose corn syrup. Additionally, preservatives and buffering agents are also known to be useful for such compositions. The problem with such known compositions is the introduction of a caloric burden by the inclusion of high fructose corn syrup, e.g., 350 parts high fructose corn syrup to one part sucralose. An additional problem with such compositions is that the high concentration of sugars may result in the formation of crystals or dried residue in the sprayer orifice. This problem is especially likely to occur in low humidity environments, or when the dispensing mechanism is used infrequently.

What is needed, therefore, is a sprayable sweetening composition that does not introduce a caloric burden, is non-foaming, and does not use supercritical fluid, optionally in combination with flavors in the form of a spray or aerosol to foods just prior to their consumption.

### SUMMARY OF THE INVENTION

The present invention is directed to a device for sweetening products including a sweetening solution, wherein the sweetening solution contains a high intensity sweetener and a solvent, and a spraying apparatus.

The present invention is also directed to sweetening composition consisting essentially of a high intensity sweetener and a solvent.

Another object of the present invention is a non-foam forming aerosol food sweetening composition having a high intensity sweetener solution, the high intensity sweetener solution consisting essentially of a high intensity sweetener dissolved in a solvent and a vessel for containing the high intensity sweetener solution, the vessel comprising a propellant for producing the aerosol, wherein the pressure exerted by the propellant is less than about 2000 psi.

A further object of the present invention is a non-aerosol spray food sweetening composition having a high intensity sweetener concentrate substantially free of nutritive sweetener, wherein the high intensity sweetener is contained within a suitable spray device.

A still further object of the present invention is a liquid composition for sweetening having a sucralose solution, wherein sucralose, present at a concentration of from about 0.2 to about 30 weight percent of the sucralose solution, is dissolved in an ingestible solvent and wherein the sucralose solution is contained within a sealed vessel, wherein the sealed vessel comprises a spraying means.

### DETAILED DESCRIPTION OF THE INVENTION

Sucralose, or 4,1′,6′-trichloro-4,1′,6′-trideoxygalactosucrose, a sweetener with a sweetness intensity several hundred times that of sucrose, is derived from sucrose by replacing the hydroxyl groups in the 4, 1′, and 6′ positions with chlorine. Synthesis of sucralose is technically challenging because of the need to selectively replace specific hydroxyl groups with chlorine, while preserving other hydroxyl groups including a highly reactive primary hydroxyl group. Numerous approaches to this synthesis are known.

Sucralose from these and other methods of synthesis may be advantageously used for in the compositions and devices of this invention. Such useful sucralose is not limited to any material obtained from any particular synthetic route. Because of its intense sweetness, other advantageous sensory attributes, and its good stability in solution, sucralose may be advantageously used in the compositions and devices of the present invention.

In addition to sucralose, other sweeteners may be used within the meaning of HIS in this invention. Such sweeteners include aspartame, neotame, saccharin, cyclamate, acesulfame, thaumatin (or katemfe), neohesperidin, and other high intensity sweeteners with sufficient solubility in water or other food grade solvents. Additional sweeteners suitable for the purposes of this invention include stevia (extract of the leaf of Stevia rebaudiana); hernandulcin (extract of Phyla scaberrima); monellin, an extract of the serendipity berry (Dioscorophyllum cumminsii); brazzein, an extract of the fruit of Pentadiplandra brazzeana; and mogroside, from the fruit of Siraitia grosvernorii. For the purposes of this invention, any of the aforementioned sweeteners may be used alone, or they may be used in combination with other HIS.

Sweetness intensity of the compositions of the present invention can of course be increased by increasing the concentration of sucralose to levels of up to 300 mg/ml. The actual level of sweetener in the concentrate or solution is determined by the sweetening needs of the intended product applications and the volume of material dispensed at each use.

The sweeteners herein described may also be termed “non-nutritive sweeteners.” Although some of these sweeteners may be metabolized by the body and yield some slight nutrient value, any nutrient value will be quite small because the levels of ingestion of these sweeteners is quite low under normal circumstances. Hence the term “non-nutritive sweeteners” is appropriate for these materials regardless of their metabolic fate.

In preparing the spray sweetener according to the present invention, an appropriate amount of sucralose, other HIS, or a mixture thereof is dissolved in water, or another appropriate food grade solvent, such as, ethanol, to achieve the desired sweetness delivery amount. This produces a high intensity sweetener solution or concentrate. The specific concentration of HIS is determined in part by the intensity of the selected sweetener or sweeteners used and the amount of solution dispensed as an aerosol during use. The amount and coverage of the high intensity sweetener solution dispensed should be sufficient to provide uniform coverage of the solution over the surface of the food to which it is applied. However, the volume of solution dispensed should not be so great as to cause sogginess or other obvious alterations in the textural properties of the food to which it is applied.

The composition of the present invention may utilize a single high intensity sweetener such as sucralose, or it may contain a combination of sweeteners such as sucralose and saccharin.

When sucralose is used as the only HIS in the HIS solution, the concentration of sucralose is from about 0.01 to about 30 weight percent of the HIS solution, or from about 0.1 to about 5 weight percent of the HIS solution, or from about 0.2 to about 3 weight percent of the HIS solution. Other high intensity sweeteners may of course be used at concentrations that will provide equivalent levels of sweetness.

The amount of high intensity sweetener solution delivered to the food product is preferably about 0.1 ml to about 5 ml, more preferably about 0.2 ml to about 2.5 ml, and most preferably about 0.5 ml to about 1.5 ml.

Also important is avoiding foam generation on the surface of the treated food, as the foam is visually unappealing in many applications and often indicates less than uniform coverage of the high intensity sweetener solution. For the purposes of this invention, “non-foam forming” means that no foam from the application of the high intensity sweetener solution remains on the surface of the food for more than 10 seconds after application. To aid in preparing a non-foam forming composition an antifoam agent may be added to the sweetener solutions. Examples of suitable antifoam agents include simethicone, dimethicone, polydimethylsiloxane, and mixtures thereof.

The high intensity sweetener concentrate may contain only the HIS dissolved in a suitable solvent, or it may additionally include buffers, stabilizers, preservatives, flavors, and mixtures thereof. Examples of sucralose solutions include those embodied in Examples I through XII of U.S. Pat. No. 5,384,311, which is incorporated herein in entirety by reference.

The HIS solution may be delivered by a spray device. Such device includes pump-type or squeeze-type sprayer, or alternatively, incorporated into a pressurized aerosol container.

The compositions embodied in this invention are free of added nutritive sweeteners. Such nutritive sweeteners include, but are not limited to, sucrose, glucose, high fructose corn syrup, or fructose. As a result of the low sweetness potency of these sweeteners (compared to HIS), relatively little additional sweetness is provided by incorporating these nutritive sweeteners into the spray compositions that are dispensed in small volumes. Frequently food ingredients, such as, flavors that may be used in this invention, contain some levels of nutritive sweeteners to serve as fillers or stabilizing agents. Therefore, the compositions of this invention may contain small amounts of nutritive sweeteners introduced from other ingredients. It is contemplated that generally any nutritive sweetener introduced from other food ingredients will be less than about 5 to about 10 weight percent of the final composition.

Although nutritive sweeteners do not contribute substantially to the sweetness imparted by the compositions disclosed herein, inclusion of these nutritive sweeteners into the spray composition would provide an excellent substrate for the growth of many microorganisms. To control this susceptibility to microbial growth, there is a need to incorporate into nutritive sweetener containing spray compositions substantial levels of antimicrobial preservatives such as benzoic acid, sorbic acid, methyl paraben, propyl paraben, butyl paraben, and mixtures thereof. These antimicrobial preservatives have significant adverse taste impacts, contributing notes of bitterness or sourness.

Alternatively, pastuerization or sterilization techniques could be used to prevent microbial spoilage of sweetener spray compositions containing nutritive sweeteners. However, such techniques add cost and complexity to manufacturing operations, and the heat exposure resulting from these processes can also have adverse effects on taste of the sweetener composition.

HIS spray compositions without added nutritive sweeteners thus provide a better tasting composition with less risk of microbial spoilage, in contrast to sweetener compositions that also contain nutritive sweeteners. Sucralose is especially desirable for the compositions of this invention because of its resistance to attack by microorganisms. The amount of antimicrobial preservatives needed to attain adequate preservation in a sucralose solution can be reduced in comparison to the amount needed in a nutritive sweetener containing composition.

A variety of mechanical approaches may be used to dispense the sweetener compositions described herein. One contemplated embodiment of the invention is dispensing the HIS solution from a squeeze bottle, which generates a spray by means of a pump handle or by a squeeze mechanism by which physical pressure is exerted on the container holding the sweetener composition, and the solution is expelled through a narrow orifice, creating a spray or aerosol.

The above described squeeze bottle is distinguished from aerosol containers, in which a propellant is incorporated inside a pressure-resistant vessel in which the sweetener composition is also contained. A number of propellant gases may be used, including, but not limited to, propane, butane, carbon dioxide, compressed air, fluorocarbon derivatives, and mixtures thereof. The fluorocarbon derivatives are generally less suitable because of possible adverse environmental consequences of their use. The propellant and sweetener concentrate may be contained within the same chamber of the aerosol container. Alternatively, the aerosol container may be partitioned into two or more separate chambers by the use flexible membranes or diaphragms. In this embodiment, the pressure of the propellant squeezes the membrane or diaphragm, thereby indirectly causing the sweetener composition to be under pressure.

The invention of this disclosure includes the physical means of generating and dispersing a spray or aerosol as mentioned above, and include but are not limited to spray bottles, squeeze bottles, and pressurized or aerosol devices.

One embodiment of the present invention is an aerosol spray that delivers the sweetness equivalent of one teaspoon of sugar each time the spray actuator is fully depressed or the pump spray handle depressed or the bottle squeezed. One teaspoon of sugar (table sugar, or sucrose from a beet or cane source) weighs about 4 g. Since sucralose is about 600 times as sweet as table sugar, the amount of sucralose needed to provide equivalent sweetness is about 0.0067 g or 6.7 mg. If the amount of solution dispensed per use is designed to be 1.0 ml, then the concentration of sucralose would be 6.67 mg/ml, or 6.67 g/l (0.667% weight/volume).

### EXAMPLE 1

A 150 ml portion of water was placed in container, and 350 mg of sucralose was added, and the contents were stirred to dissolve. This yielded a high intensity sweetener concentrate containing about 2.3 mg/ml of sucralose. The solution so obtained was placed in a pump spray bottle (Ace Hardware All Purpose Sprayer). Each full depression of the spray bottle handle dispensed a mean of 1.35 ml of the high intensity sweetener solution.

The spray bottle so prepared was used to spray the solution onto a bowl of cereal (Cheerios®, General Mills, Inc.) to which skim milk had been previously added. One depression of the spray bottle handle was made while the spray bottle nozzle was held about 20 cm from the cereal, and the spray bottle was rotated over the top of the bowl in a circular manner during dispensing of the sweetener. The cereal in the bowl was found to be lightly but pleasantly sweetened. In particular, the sweetness remained localized on the surface of the cereal, instead of becoming generally dispersed in the milk.

### EXAMPLE 2

A more microbiologically stable form of Example 1 is prepared by adding 150 mg each of potassium sorbate and sodium benzoate to the solution prepared as described in Example 1, and then stirring to achieve dissolution of these materials. Finally, 272 mg of anhydrous citric acid and 258 mg of sodium citrate dihydrate are added, and stirring is continued until all materials are fully dissolved. This composition is resistant to growth of spoilage microorganisms.

### EXAMPLE 3

A sucralose solution containing antimicrobial preservatives and a buffer system is prepared as described in Example 2. Approximately 200 ml of solution are placed in an empty steel aerosol can. The can is then pressurized by the addition of a charge of liquid propane, and the can is sealed and fitted with a spray actuator. The orifice of the spray actuator is designed so that, when the can is fully charged with propellant, about 0.5 ml of solution is dispensed over a 5 second interval. Approximately one cup of sliced, capped strawberries is placed in an open bowl. The actuator of the aerosol can is held about 10 cm above the surface of the strawberries, and the actuator is depressed for 5 seconds while the spray is gently directed over the entire surface of the fruit. The fruit is found to be evenly sweetened on the surface, and the addition of sweetener by this method does not result in powdered material on the surface of the fruit, or an excessive amount of moisture on the fruit.

### EXAMPLE 4

One liter of ingestible grade, non-denatured 70% ethanol is placed into a large covered beaker. With gentle stirring, 6.67 g of sucralose are gradually added, and stirring is maintained until dissolution is complete. Ethyl vanillin (1 g) is then added, and dispersed in the solution by stirring. The solution is then dispensed into a pump-type spray dispenser bottle as described in Example 1. Sliced bread made from white wheat flour is gently toasted, and spread with a thin coating of Benecol® spread (McNeil Nutritionals). The spray bottle is held about 15 cm above the surface of each slice of toast, and the spray handle is squeezed once over each slice of toast. The toast possesses a pleasant sweet taste with a vanilla note; the toast remains crisp, and is not rendered soggy by the amount of solution sprayed onto the surface.

### EXAMPLE 5

One liter of ingestible grade, non-denatured 70% ethanol is placed into a large covered beaker. With, gentle stirring, 6.67 g of sucralose is gradually added, and stirring maintained until dissolution is complete. Caramel flavor (1 g) is added, along with caramel color (1 g). These materials are dispersed by stirring, and the solution is dispensed into a pump-type spray dispenser bottle as described in Example 1. Popcorn is prepared in a microwave corn popper to provide approximately one liter of popped corn. While the corn is still warm, the spray bottle is held about 20 cm above the surface of the popcorn, and the spray handle is squeezed 10 times while the popcorn is stirred with a spoon. The corn is found to have a sweet, caramel taste and a pleasing color.

### EXAMPLE 6

The composition of Example 1 is prepared. Additionally, 0.1 ml of a 1:10 aqueous dilution of AntiFoam AF emulsion (30% simethicone polymers, Dow Corning) is added with through mixing, and the solution is placed in a spray bottle. The solution is sprayed onto the surface of a food product; no residual foam remains on the surface of the food. The antifoam agent can be used to prevent the formation of foam when other materials with a foaming tendency are also incorporated into the composition.

1-51. (canceled)

52. method of sweetening solid food comprising
providing a solid food, providing a sweetening solution in a spraying apparatus, wherein the sweetening solution consists essentially of a high intensity sweetener and a solvent, and applying a sweetening solution to the solid food.

53. The method of claim 52, wherein the solid food is selected from the group consisting of a pastry, a doughnut, a fruit, a cereal, popcorn, and bread.

54. The method of claim 53, wherein the high intensity sweetener is selected from the group consisting of sucralose, aspartame, neotame, acesulfame, saccharine, and mixtures thereof.

55. The method of claim 54, wherein the high intensity sweetener is sucralose and acesulfame.

56. The method of claim 55, wherein the high intensity sweetener is sucralose.

57. The method of claim 52, wherein the solvent is selected from the group consisting of water, ethanol, ethyl acetate, propylene glycol, and mixtures thereof.
